(19) United States
(12) Patent Application Publication
(10) Pub. No.: US 2005/0276470 A1
(43) Pub. Date: Dec. 15, 2005

(54) Saturation-adaptive image enhancement apparatus and method

(76) Inventors: Moon-cheol Kim, Suwon-si (KR); Jae-hwan Oh, Suwon-si (KR)

Correspondence Address: STANZIONE & KIM, LLP, 919 18TH STREET, N.W., SUITE 440, WASHINGTON, DC, 20006, US

(21) Appl. No.: 11/140,983

(22) Filed: Jun. 1, 2005

(30) Foreign Application Priority Data
Jun. 9, 2004 (KR) 2004-42165

(51) Int. Cl. G06K 9/00; G06K 9/40

(52) U.S. Cl. 382/162; 382/254

(57) ABSTRACT

A saturation-adaptive image enhancement apparatus and method enhances image quality by calculating a saturation level pixel by pixel of an input image and adjusts the saturation of the pixels according to the calculated saturation level. The saturation-adaptive image enhancement apparatus includes a saturation level calculation unit to calculate a saturation level of an input color signal; a weight and gain calculation unit to calculate a luminance weight and a saturation gain to be applied to a luminance change of the input color signal by using the calculated saturation level; an image enhancement unit to adjust a luminance of the input color signal according to a certain algorithm and to output the adjusted luminance and the luminance of the input color signal; and a luminance adaptation unit to adjust the luminance of the input color signal by using one of the luminance weight and the saturation gain, which are calculated at the weight and gain calculation unit, and the adjusted luminance output from the image enhancement unit. Accordingly, server luminance change can be prevented during the color gamut mapping by adjusting the luminance of the input color signal according to the saturation level of the input color signal.

### CROSS-REFERENCE TO RELATED APPLICATIONS

This application claims the benefit of Korean Patent Application No. 2004-42165 filed with the Korea Industrial Property Office on Jun. 9, 2004, the disclosure of which is incorporated herein by reference in its entirety.

### BACKGROUND OF THE INVENTION

1. Field of the Invention

The present general inventive concept generally relates to a saturation-adaptive image enhancement apparatus and method. More specifically, the present general inventive concept relates to a saturation-adaptive image enhancement apparatus and method to calculate a saturation level pixel by pixel of an input image, and to adjust a luminance of pixels according to the calculated saturation level.

2. Description of the Related Art

A color signal processing device and method to enhance image quality is disclosed in Korean Patent Application No. 2004-0013582. According to the above described document, the saturation of an input signal and a maximum saturation with respect to the hue of the input signal are read from a color gamut table being organized in advance, a hue value of the input color signal is determined based on the ratio of the two read values.

FIG. 1 is a block diagram of the conventional color signal processing apparatus disclosed in Korean Patent Application No. 2004-0013582.

Referring to FIG. 1, the color signal processing device includes a calculating unit 101, a coordinate storing unit 103, a color gamut determining unit 105, and a signal processing unit 107.

The calculating unit 101 calculates brightness, saturation, and hue corresponding to an input RGB color signal. The coordinate storing unit 103 stores a coordinate value including the brightness and the saturation of each color categorized according to predetermined levels.

The color gamut determining unit 105 determines a color gamut of a display that displays the input RGB color signals. The color gamut determining unit 105 extracts from the coordinate storing unit 103 the coordinate corresponding to a calculated color by the calculating unit 101, and determines a displayable range of the brightness and the saturation of the display based on the extracted coordinate, and the brightness and the saturation calculated by the calculating unit 101. The signal processing unit 107 digitizes the input RGB color signals within the color gamut determined by the color gamut determining unit 105, and converts and outputs the digitized color signals on the display as the RGB color signals.

The conventional color signal processing device and method prevents the adjusted brightness from exceeding the color gamut by determining whether the brightness of the color signal falls within or out of the color gamut. However, a memory is required to store a color gamut table since the conventional color signal processing device utilizes the color gamut table organized in advance.

In addition, the displayed colors are subjected to distortion as conventional algorithms used to enhance a contrast of the input image uniformly adjust the brightness of the input image without taking into account the saturation of the input image.

### SUMMARY OF THE INVENTION

The present general inventive concept provides a saturation-adaptive image enhancement apparatus and method to enhance image quality by calculating a saturation level pixel by pixel of an input image and adjusting the saturation of the pixels according to the calculated saturation level.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a saturation-adaptive image enhancement apparatus including a saturation level calculation unit to calculate a saturation level of an input color signal; a weight and gain calculation unit to calculate a luminance weight and a saturation gain to be applied to a luminance change of the input color signal by using the calculated saturation level; an image enhancement unit to adjust a luminance of the input color signal according to a certain algorithm and to output the adjusted luminance and the luminance of the input color signal; and a luminance adaptation unit to adjust the luminance of the input color signal by using one of the luminance weight and the saturation gain, which are calculated at the weight and gain calculation unit, and the adjusted luminance output from the image enhancement unit.

The foregoing and/or other aspects and advantages of the present general inventive concept are also achieved by providing a saturation-adaptive image enhancement method including: calculating a saturation level of an input color signal; calculating a luminance weight and a saturation gain to be applied to a luminance change of the input color signal by using the calculated saturation level; adjusting a luminance of the input color signal according to a certain algorithm and outputting the adjusted luminance and the luminance of the input color signal; and adjusting the luminance of the input color signal by using one of the luminance weight and the saturation gain, and the adjusted luminance.

The saturation level is calculated based on the following equation:

$$\begin{matrix}S = maximum ( S1 , S2 ) \\ S1 = \frac{Max 1 - Min 1}{Max 1} \\ S2 = \frac{Max 2 - Min 2}{Max 2} ,\end{matrix}$$

wherein S is the saturation level obtained at the saturation level calculation unit, Min1=minimum(R, G, B). Max1=maximum (R, G, B), Min2=minimum((255-R), (255-G), (255-B)), and Max2=maximum((255-R), (255-G), (255-B)).

The luminance weight and the saturation gain can be calculated based on the following equation:

$$W = {S}^{k}$$

$$if S < th1 , {g}_{sat} = 1$$

$$if th1 \leq S < th2 , {g}_{sat} = \frac{( S - th1 )}{th1 - th2} + 1$$

$$if S \geq th2 , {g}_{sat} = 0 ,$$

wherein W is the luminance weight, S is the saturation level, th1 is a first threshold, th2 is a second threshold, and gₛₐₜ is the saturation gain.

The luminance of the input color signal can be adjusted and output using one of the following equations:
Yₒ=W×Y+(1−W)Xₑₙₕ, and
Yₒ=Y+ΔY×gₛₐₜ, ΔY=Yₑₙₕ−Y,
wherein Yₒ is a final output luminance, W is the luminance weight, Yₑₙₕ is an adjusted luminance, Y is the luminance of the input color signal, and gₛₐₜ is the saturation gain obtained.

The saturation-adaptive image enhancement apparatus may further include a color space conversion unit to convert a color space of the input color signal and output the input color signal having the converted color space to the saturation level calculation unit.

The certain algorithm may be a contrast enhancement algorithm or a black and white stretch algorithm.

### BRIEF DESCRIPTION OF THE DRAWINGS

These and/or other aspects and advantages of the present general inventive concept will become apparent and more readily appreciated from the following description of exemplary embodiments, taken in conjunction with the accompanying drawing figures of which:

FIG. 1 is a block diagram of a conventional color signal processing apparatus to enhance image quality;

FIG. 2 is a block diagram of a saturation-adaptive image enhancement apparatus according to an embodiment of the present general inventive concept;

FIG. 3A is a graph illustrating a luminance weight calculated at the weight and gain calculation unit of FIG. 2;

FIG. 3B is a graph illustrating a saturation gain calculated at the weight and gain calculation unit of FIG. 2; and

FIG. 4 is a flowchart of a saturation-adaptive image enhancement method according to an embodiment of the present general inventive concept.

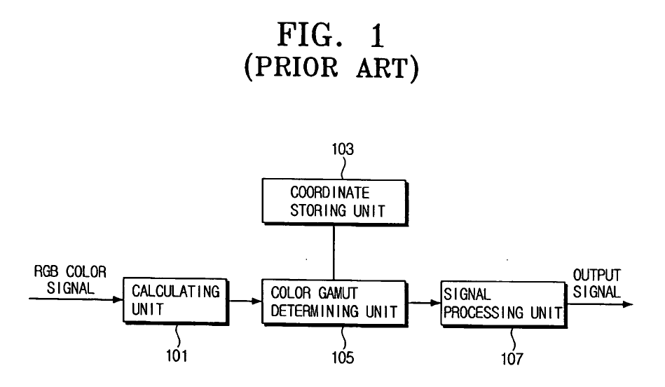

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

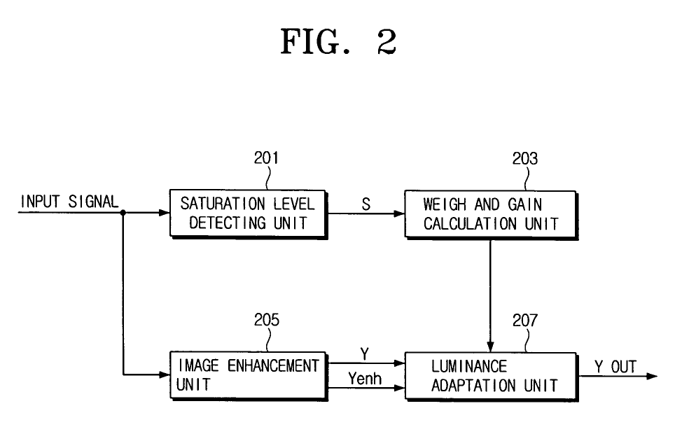

FIG. 2 is a block diagram illustrating a saturation-adaptive image enhancement apparatus according to an embodiment of the present general inventive concept.

Referring to FIG. 2, the saturation-adaptive image enhancement apparatus can include a saturation level calculation unit 201, a weight and gain calculation unit 203, an image enhancement unit 205, a luminance adaptation unit 207, and a gamut mapping unit (not shown).

The saturation level calculation unit 201 calculates a saturation level of an input color signal. The input color signal may be a RGB color signal, a YCbCr color signal or the like. If it is required, the saturation level of the input color signal may be calculated after converting the input color signal into a color space.

The weight and gain calculation unit 203 calculates a luminance (brightness) weight to be applied to the input color signal and a saturation gain by using the saturation level obtained at the saturation level calculation unit 201. The luminance weight and the saturation gain are utilized to adjust the luminance of the input color signal. The luminance weight is calculated and used to soft-switch between the luminance of an input image and the adjusted luminance. The saturation gain is used to determine the change of the adjusted luminance to be applied when the luminance of the input image is adjusted.

The image enhancement unit 205 outputs the adjusted luminance with respect to the luminance of the input image. The image enhancement unit 205 can employ conventional image enhancement algorithms including a contrast enhancement algorithm to adjust the luminance of the input color signal, and a black and white stretch algorithm to adjust the luminance in black and white regions. The image enhancement unit 205 outputs the adjusted luminance and the luminance of the input image.

The luminance adaptation unit 207 receives the luminance of the input image and the adjusted luminance from the image enhancement unit 205, and calculates a final output luminance using the luminance weight or the saturation gain received from the weight and gain calculation unit 203. When the luminance of the input color signal is increased or decreased, the final luminance is output by applying the adjusted luminance of the image enhancement unit 205 differently according to the saturation level, rather than simply outputting the adjusted luminance at the image enhancement unit 205. As for the input image with lower saturation pixels, the adjusted luminance at the image enhancement unit 205 is applied to increase or decrease the luminance value of the input image pixels. In contrast, the input image with higher saturation pixels is output close to the luminance value of the input color signal.

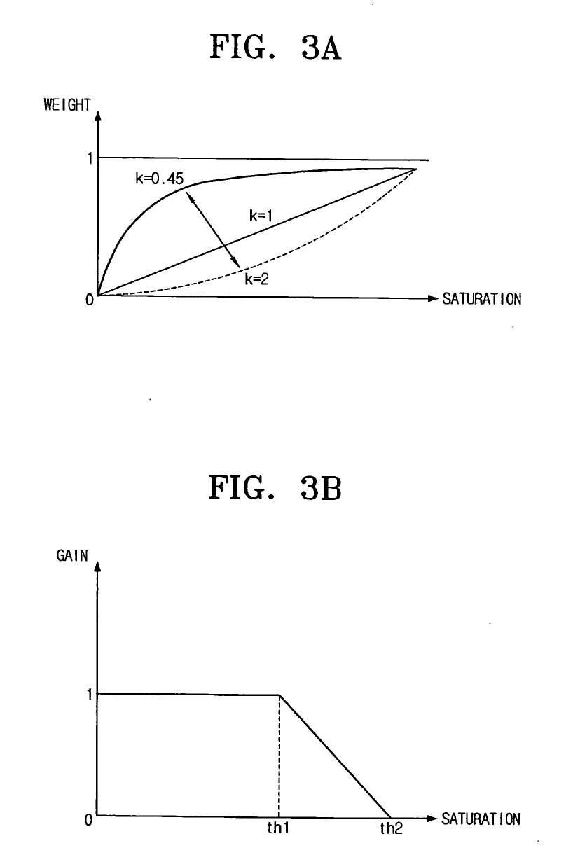

FIG. 3A illustrates the luminance weight calculated with respect to saturation at the weight and gain calculation unit 203 of FIG. 2.

The calculated luminance weight ranges between 0 and 1 and varies depending on a constant k as illustrated in FIG. 3A. The constant k ranges between 0 and 2. As the constant k approaches 0, the luminance weight becomes closer to 1. If the constant k is 1, the luminance weight is represented as the line illustrated in FIG. 3A, and if the constant k is 2, the luminance weight is represented as the quadratic function curve, as illustrated in FIG. 3A.

FIG. 3B illustrates the saturation gain calculated with respect to saturation at the weight and gain calculation unit 203 of FIG. 2.

In FIG. 3B, the regions below a first threshold th1 is a low-saturation region where the saturation gain is 1. The region between the first threshold th1 and a second threshold th2 is a middle saturation region. In the middle saturation region, as the saturation value approaches the second threshold th2, the saturation gain decreases. The region over the second threshold th2 is a high saturation region where the saturation gain is 0. In short, the output color signal is equal to the input color signal within the high saturation region.

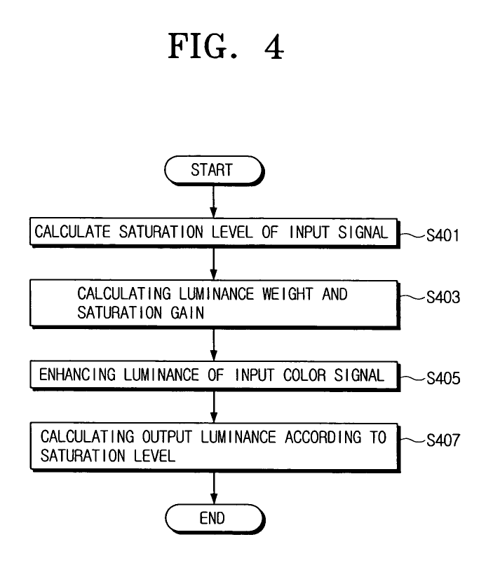

FIG. 4 is a flowchart illustrating a saturation-adaptive image enhancement method according to an embodiment of the present general inventive concept.

Referring to FIG. 4, the saturation level calculation unit 201 calculates the saturation level of the input color signal (operation S401). The saturation level is calculated to variously increase or decrease the luminance according to the saturation level of the input image pixels.

The saturation level calculation unit 201 calculates the saturation level of the relevant pixel of the input image in accordance with the following equation:

$$\begin{matrix}S = maximum ( S1 , S2 ) \\ S1 = \frac{Max 1 - Min 1}{Max 1} \\ S2 = \frac{Max 2 - Min 2}{Max 2} .\end{matrix} \qquad [ Equation 1 ]$$

In Equation 1, S is the saturation level obtained at the saturation level calculation unit 201, and is a maximum value at S1 and S2. Min1 is a minimum value in R, G, and B values (Min1=minimum(R, G, B)). Max1 is a maximum value in R, G, and B values (Max1=maximum (R, G, B)). Min2 is a minimum value in (255-R), (255-G), and (255-B) (Min2=minimum((255-R), (255-G), (255-B))). Max2 is a maximum value in (255-R), (255-G), and (255-B) (Max2=maximum((255-R), (255-G), (255-B))). Note that Equation 1 relates to the RGB color signal, but can be used to calculate the saturation level with respect to a YCbCr color signal or other various color signals as well. Alternatively, the saturation level of the input color signal can be obtained by converting the input color signal into a color space.

Next, the luminance weight and the saturation gain to be applied to the adjustment of the luminance of the input color signal are calculated according to the saturation level obtained at the saturation level calculation unit 201 (operation S403). The luminance weight calculated at the weight and gain calculation unit 203 is used to soft-switch between the luminance of the input image and the adjusted luminance, and the saturation gain is calculated to apply change of the adjusted luminance to the luminance of the input image. The luminance weight and the saturation gain, being calculated at the weight and gain calculation unit 203, are provided to the luminance adaptation unit 207.

The luminance weight is calculated in accordance with the following equation:
W=S^{k}. [Equation 2]

In Equation 2, W is the luminance weight, S is the saturation level ranging between 0 and 1, and k is a constant ranging between 0 and 2. The luminance weight according to the constant k is represented as in FIG. 3A.

The saturation gain is obtained in accordance with the following equation:

$$\begin{matrix}{g}_{sat} = 1 , S < th1 \\ {g}_{sat} = \frac{( S - th1 )}{th1 - th2} + 1 , th1 \leq S < th2 \\ {g}_{sat} = 0 , S \geq th2 .\end{matrix} \qquad [ Equation 3 ]$$

In Equation 3, S is the saturation level obtained at the saturation level calculation unit 201, th1 is a first threshold, th2 is the second threshold, and gₛₐₜ is the saturation gain. The first threshold is the value to discriminate between the low saturation region and the middle saturation region of the input image. The second threshold is a value to discriminate between the middle saturation region and the high saturation region of the input image.

The saturation gain is represented according to the first and second thresholds, as illustrated in FIG. 3B. The saturation gain is 1 in the low saturation region covering the saturation region below the first threshold. In the middle saturation region covering the saturation between the first threshold and the second threshold, the slope represents the saturation gain, as illustrated in FIG. 3B. In the high saturation region covering the saturation over the second threshold, the saturation gain is 0.

The luminance of the input color signal is adjusted at the image enhancement unit 205 (operation S405). The adjusted luminance and the luminance of the input color signal are provided to the luminance adaptation unit 207. The image adjustment can be achieved using conventional image enhancement algorithms such as a contrast enhancement algorithm to adjust the luminance of the input color signal, and a black and white stretch algorithm to adjust the luminance only in black and white regions.

The luminance adaptation unit 207 increases or decreases the luminance of the input color signal depending on the saturation level of the input color signal by use of the output from the image enhancement unit 205, and the luminance weight and the saturation gain calculated at the weight and gain calculation unit 203 (operation S407).

The luminance of the input color signal is adjusted using the luminance weight provided from the weight and gain calculation unit 203 in accordance with the following equation:
Yₒ=W×Y+(1−W)×Yₑₙₕ. [Equation 4]

In Equation 4, Yₒ is the final output luminance, W is the luminance weight, Yₑₙₕ is the adjusted luminance at the image enhancement unit 205, and Y is the luminance of the input color signal.

The luminance of the input color signal is adjusted using the saturation gain obtained at the weight and gain calculation unit 203 in accordance with the following equation:
Yₒ=Y+ΔY×gₛₐₜ, ΔY=Yₑₙₕ−Y. [Equation 5]

In Equation 5, Yₒ is the final output luminance, Y is the luminance of the input color signal, Yₑₙₕ is the adjusted luminance at the image enhancement unit 205, and gₛₐₜ is the saturation gain.

The luminance of the input color signal is adjusted according to the saturation level based on Equation 4 by applying the luminance weight calculated at the weight and gain calculation unit 203 to the luminance of the input color signal depending on the saturation level obtained at the saturation level calculation unit 201. As the luminance weight gets closer to 1, the final output luminance is output closer to the luminance value of the input color signal. In this situation, the saturation value is quite large in reference to Equation 2 and FIG. 3A. Hence, in the high saturation region, the final output luminance is output closer to the luminance of the input color signal.

As the luminance weight approaches 0, the adjusted luminance at the image enhancement is applied to the final output luminance in Equation 4. The luminance weight close to 0 has the smaller saturation value in reference to Equation 2 and FIG. 3A. In the low saturation region, the image enhancement algorithm at the image enhancement unit 205 is applied to the final output luminance. More specifically, if the image enhancement algorithm increases the luminance of the input color signal, the final output luminance is the increased luminance of the input color signal. If the image enhancement algorithm decreases the luminance of the input color signal, the final output luminance is the decreased luminance of the input color signal.

The luminance of the input color signal is adjusted based on Equation 5 by applying the saturation gain obtained at the weight and gain calculation unit 203 to the difference ΔY between the adjusted luminance at the image enhancement unit 205 and the luminance of the input color signal according to the saturation level calculated at the saturation level calculation unit 201. As the saturation gain approaches 0, the final output luminance is output closer to the luminance value of the input color signal. In this case, the saturation value is over the second threshold in reference to Equation 3 and FIG. 3B. In the high saturation region, the final output luminance is output closer to the luminance of the input color signal.

In contrast, as the saturation gain approaches 1, the adjusted luminance at the image enhancement unit 205 is applied to the final output luminance. In this situation, the saturation value is below the first threshold in relation to Equation 3 and FIG. 3B. In the low saturation region, the image enhancement algorithm at the image enhancement unit 205 is applied to the final output luminance.

In Equations 4 and 5, the luminance adaptation unit 207 applies the adjusted luminance of the image enhancement unit 205 to the lower saturation pixels of the input image, and thus adjusts the luminance value of the input image pixels. In contrast, the input image pixels having the higher saturation are output closer to the luminance value of the input color signal. In the event that the image enhancement algorithm increases the luminance of the input color signal, the luminance adaptation unit 207 outputs the final output luminance with the increased luminance value from the input color signal. In the event that image enhancement algorithm decreases the luminance of the input color signal, the final output luminance is output with the decreased luminance value from the input color signal.

In light of the foregoing embodiments as described above, the luminance of the input color signal can be adjusted depending on the saturation level, thus preventing severe luminance change during the color gamut mapping. In further detail, the color signal is prevented from exceeding the color gamut due to the severe luminance change during the color gamut mapping. Even if the color signal does not exceed the color gamut, the color signal of a source device is prevented from mapping to a random color.

Compared with the luminance adjustment of the input color signal that increases noises, the luminance of the input color signal is adjusted depending on the saturation level. Therefore, it is possible to attenuate noises having a different saturation level from neighboring pixels.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A saturation-adaptive image enhancement apparatus comprising:
a saturation level calculation unit to calculate a saturation level of an input color signal;
a weight and gain calculation unit to calculate a luminance weight and a saturation gain to be applied to a luminance change of the input color signal by using the calculated saturation level;
an image enhancement unit to adjust a luminance of the input color signal according to a certain algorithm and to output the adjusted luminance and the luminance of the input color signal; and
a luminance adaptation unit to adjust the luminance of the input color signal by using one of the luminance weight and the saturation gain, which are calculated at the weight and gain calculation unit, and the adjusted luminance output from the image enhancement unit.

2. The saturation-adaptive image enhancement apparatus of claim 1, wherein the saturation level calculation unit calculates the saturation level based on the following equation:
$$\begin{matrix}S = maximum ( S1 , S2 ) \\ S1 = \frac{Max 1 - Min 1}{Max 1} \\ S2 = \frac{Max 2 - Min 2}{Max 2} ,\end{matrix}$$
wherein S is the saturation level obtained at the saturation level calculation unit, Min1=minimum(R, G, B). Max1=maximum (R, G, B), Min2=minimum((255-R), (255-G), (255-B)), and Max2=maximum((255-R), (255-G), (255-B)).

3. The saturation-adaptive image enhancement apparatus of claim 1, wherein the weight and gain calculation unit calculates the luminance weight and the saturation gain based on the following equation:
$$W = {S}^{k}$$
$$if S < th1 , {g}_{sat} = 1$$
$$if th1 \leq S < th1 , {g}_{sat} = \frac{( S - th1 )}{th1 - th2} + 1$$
$$if S \geq th2 , {g}_{sat} = 0 ,$$
wherein W is the luminance weight, S is the saturation level obtained at the saturation level calculation unit, th1 is a first threshold, th2 is a second threshold, and gₛₐₜ is the saturation gain.

4. The saturation-adaptive image enhancement apparatus of claim 4, wherein the luminance adaptation unit adjusts and outputs the luminance of the input color signal using one of the following equations:
Yₒ=W×Y+(1−W)×Yₑₙₕ, and
Yₒ=Y+ΔY×gₛₐₜ, ΔY=Yₑₙₕ−Y,
wherein Yₒ is a final output luminance output from the luminance adaptation unit, W is the luminance weight calculated at the weight and gain calculation unit, Yₑₙₕ is an adjusted luminance at the image enhancement unit, Y is the luminance of the input color signal from the image adaptation unit, and gₛₐₜ is the saturation gain obtained at the weight and gain calculation unit.

5. The saturation-adaptive image enhancement apparatus of claim 1, further comprising a color space conversion unit to convert a color space of the input color signal and output the input color signal having the converted color space to the saturation level calculation unit.

6. The saturation-adaptive image enhancement apparatus of claim 1, wherein the certain algorithm is a contrast enhancement algorithm or a black and white stretch algorithm.

7. The saturation-adaptive image enhancement apparatus of claim 1, wherein the input color signal is converted into a color space before the saturation level of the input color signal is calculated.

8. A saturation-adaptive image enhancement method, comprising:
calculating a saturation level of an input color signal;
calculating a luminance weight and a saturation gain to be applied to a luminance change of the input color signal by using the calculated saturation level;
adjusting a luminance of the input color signal according to a certain algorithm and outputting the adjusted luminance and the luminance of the input color signal; and
adjusting the luminance of the input color signal by using one of the luminance weight and the saturation gain, and the adjusted luminance.

9. The saturation-adaptive image enhancement method of claim 8, wherein the saturation level is calculated based on the following equation:
$$\begin{matrix}S = maximum ( S1 , S2 ) \\ S1 = \frac{Max 1 - Min 1}{Max 1} \\ S2 = \frac{Max 2 - Min 2}{Max 2} ,\end{matrix}$$
wherein S is the saturation level, Min1=minimum(R, G, B). Max1=maximum (R, G, B), Min2=minimum((255-R), (255-G), (255-B)), and Max2=maximum((255-R), (255-G), (255-B)).

10. The saturation-adaptive image enhancement method of claim 8, wherein the luminance weight and the saturation gain are calculated based on the following equation:
$$W = {S}^{k}$$
$$if S < th1 , {g}_{sat} = 1$$
$$if th1 \leq S < th2 , {g}_{sat} = \frac{( S - th1 )}{th1 - th2} + 1$$
$$if S \geq th2 , {g}_{sat} = 0 ,$$
wherein W is the luminance weight, S is the saturation level, k is a constant, th1 is a first threshold, th2 is a second threshold, and gₛₐₜ is the saturation gain.

11. The saturation-adaptive image enhancement method of claim 10, wherein saturation gain is obtained in accordance with the following equation:
$$\begin{matrix}{g}_{sat} = 1 , S < th1 \\ {g}_{sat} = \frac{( S - th1 )}{th1 - th2} + 1 , th1 \leq S < th2 \\ {g}_{sat} = 0 , S \geq th2 .\end{matrix}$$

12. The saturation-adaptive image enhancement method of claim 8, wherein the luminance of the input color signal is adjusted and output using one of the following equations:
Yₒ=W×Y+(1−W)×Yₑₙₕ, and
Yₒ=Y+ΔY×gₛₐₜ, ΔY=Yₑₙₕ−Y,
wherein Yₒ is a final output luminance, W is the luminance weight, Yₑₙₕ is an adjusted luminance, Y is the luminance of the input color signal, and gₛₐₜ is the saturation gain obtained.

13. The saturation-adaptive image enhancement method of claim 8, wherein a color space of the input color signal is converted, and the saturation level is calculated with respect to the input color signal having the converted color space.

14. The saturation-adaptive image enhancement method of claim 8, wherein the certain algorithm is a contrast enhancement algorithm or a black and white stretch algorithm.

15. A saturation-adaptive image enhancement apparatus comprising:
a weight and gain calculation unit to calculate a luminance weight and a saturation gain of an input color signal to be applied to a luminance change of the input color signal by using a calculated saturation level of the input color signal;
an image enhancement unit to adjust a luminance of the input color signal according to a certain algorithm and to output the adjusted luminance and the luminance of the input color signal; and
a luminance adaptation unit to adjust the luminance of the input color signal by using one of the luminance weight and the saturation gain, which are calculated at the weight and gain calculation unit, and the adjusted luminance output from the image enhancement unit.

16. A saturation-adaptive image enhancement method, comprising:
calculating a saturation level of an input color signal;
adjusting a luminance of the input color signal according to a certain algorithm and outputting the adjusted luminance and the luminance of the input color signal; and
adjusting the luminance of the input color signal according to the calculated saturation level.

17. The saturation-adaptive image enhancement method of claim 16, wherein the adjusting of the luminance of the input color signal based on the calculated saturation level includes calculating one of the luminance weight and the saturation gain, and the adjusted luminance, using the calculated saturation level, and using the calculated results.

18. A computer readable storage medium containing executable code providing a method of saturation-adaptive image enhancement, the method comprising:
calculating a saturation level of an input color signal;
calculating a luminance weight and a saturation gain to be applied to a luminance change of the input color signal by using the calculated saturation level;
adjusting a luminance of the input color signal according to a certain algorithm and outputting the adjusted luminance and the luminance of the input color signal; and
adjusting the luminance of the input color signal by using one of the luminance weight and the saturation gain, and the adjusted luminance.

19. The computer readable storage medium of claim 18, wherein the saturation level is calculated based on the following equation:
$$\begin{matrix}S = maximum ( S1 , S2 ) \\ S1 = \frac{Max 1 - Min 1}{Max 1} \\ S2 = \frac{Max 2 - Min 2}{Max 2} ,\end{matrix}$$
wherein S is the saturation level, Min1=minimum(R, G, B). Max1=maximum (R, G, B), Min2=minimum((255-R), (255-G), (255-B)), and Max2=maximum((255-R), (255-G), (255-B)).

20. The computer readable storage medium of claim 18, wherein the luminance of the input color signal is adjusted and output using one of the following equations:
Yₒ=W×Y+(1−W)×Yₑₙₕ, and
Yₒ=Y+ΔY×gₛₐₜ, ΔY=Yₑₙₕ−Y,
wherein Yₒ is a final output luminance, W is the luminance weight, Yₑₙₕ is an adjusted luminance, Y is the luminance of the input color signal, and gₛₐₜ is the saturation gain obtained.

21. The computer readable storage medium of claim 18, wherein the luminance weight and the saturation gain are calculated based on the following equation:
$$W = {S}^{k}$$
$$if S < th1 , {g}_{sat} = 1$$
$$if th1 \leq S < th2 , {g}_{sat} = \frac{( S - th1 )}{th1 - th2} + 1$$
$$if S \geq th2 , {g}_{sat} = 0 ,$$
wherein W is the luminance weight, S is the saturation level obtained at the saturation level calculation unit, k is a constant, th1 is a first threshold, th2 is a second threshold, and gₛₐₜ is the saturation gain.

22. The computer readable storage medium of claim 18, wherein W is the luminance weight, S is the saturation level, th1 is a first threshold, th2 is a second threshold, and gₛₐₜ is the saturation gain.

23. A computer readable storage medium containing executable code providing a method of saturation-adaptive image enhancement, the method comprising:
calculating a saturation level of an input color signal;
adjusting a luminance of the input color signal according to a certain algorithm and outputting the adjusted luminance and the luminance of the input color signal; and
adjusting the luminance of the input color signal according to the calculated saturation level.

24. The computer readable storage medium of claim 23, wherein the adjusting of the luminance of the input color signal based on the calculated saturation level includes calculating one of the luminance weight and the saturation gain, and the adjusted luminance, using the calculated saturation level, and using the calculated results.
